(19) United States
(12) Patent Application Publication
(10) Pub. No.: US 2026/0037044 A1
(43) Pub. Date: Feb. 5, 2026

(54) CONDITIONAL STATUS INDICATOR

(71) Applicant: Apple Inc., Cupertino, CA (US)

(72) Inventors: Yutaka Yokokawa, Los Gatos, CA (US); Alexandria G. Heston, San Francisco, CA (US); Amrutha Hakkare Arunachala, Sunnyvale, CA (US); In Young Yang, Kirkland, WA (US); Joshua J. Frost, Aptos, CA (US); Magnus H. Johnson, San Francisco, CA (US)

(21) Appl. No.: 19/285,327

(22) Filed: Jul. 30, 2025

Related U.S. Application Data
(60) Provisional application No. 63/677,738, filed on Jul. 31, 2024.

(51) Int. Cl. G06F 1/20; G06F 3/01; G06T 19/00

(52) U.S. Cl. CPC G06F 1/206; G06F 3/011; G06F 3/017; G06T 19/006

(57) ABSTRACT

In one implementation, a method of displaying a status indicator is performed by a device including an image sensor, a display, one or more processors, and non-transitory memory. The method includes capturing, using the image sensor, an image of a physical environment including a physical object. The method includes determining a status of the physical object. The method includes, in response to determining that the status is a first value, displaying, on the display, an indicator of the status of the physical object. The method includes, in response to determining that the status of the physical object is a second value, forgoing display of the indicator of the status of the physical object.

### CROSS-REFERENCE TO RELATED APPLICATIONS

This application claims priority to U.S. Provisional Patent App. No. 63/677,738, filed on Jul. 31, 2024, which is hereby incorporated by reference in its entirety.

### TECHNICAL FIELD

The present disclosure generally relates to systems, methods, and devices of displaying a status indicator in an extended reality (XR) environment.

### BACKGROUND

In various implementations, an extended reality (XR) environment presented by an electronic device including a display includes virtual world-locked objects indicating a status of physical devices in the XR environment to a user of the electronic device. Displaying such objects uses computational resources and can clutter a user's field-of-view.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIGS. 2A-2F illustrate a first XR environment during various time periods in accordance with some implementations.

FIGS. 3A-3C illustrate a second XR environment during various time periods in accordance with some implementations.

FIGS. 4A-4D illustrate a third XR environment during various time periods in accordance with some implementations.

FIG. 5 is a flowchart representation of a method of displaying a status indicator in accordance with some implementations.

FIG. 6 is a block diagram of an example controller in accordance with some implementations.

FIG. 7 is a block diagram of an example electronic device in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for displaying a status indicator. In various implementations, the method is performed by a device having an image sensor, a display, one or more processors, and non-transitory memory. The method includes capturing, using the image sensor, an image of a physical environment including a physical object. The method includes determining a status of the physical object. The method includes, in response to determining that the status is a first value, displaying, on the display, an indicator of the status of the physical object. The method includes, in response to determining that the status of the physical object is a second value, forgoing display of the indicator of the status of the physical object.

In accordance with some implementations, a device includes one or more processors, a non-transitory memory, and one or more programs; the one or more programs are stored in the non-transitory memory and configured to be executed by the one or more processors and the one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices and circuits have not been described in exhaustive detail so as not to obscure more pertinent aspects of the example implementations described herein.

As noted above, in various implementations, an XR environment can include virtual world-locked objects indicating the status of physical devices in the XR environment. However, displaying such objects for each physical device in the XR environment uses computational resources and can clutter a user's field-of-view. Accordingly, in various implementations, such objects are only displayed when a user selects the object, e.g., by looking at the object, gesturing at the object, vocally indicating the object, etc. However, in various implementations, such objects are also displayed without user selection when the physical device has a particular status, such as a low battery or error condition.

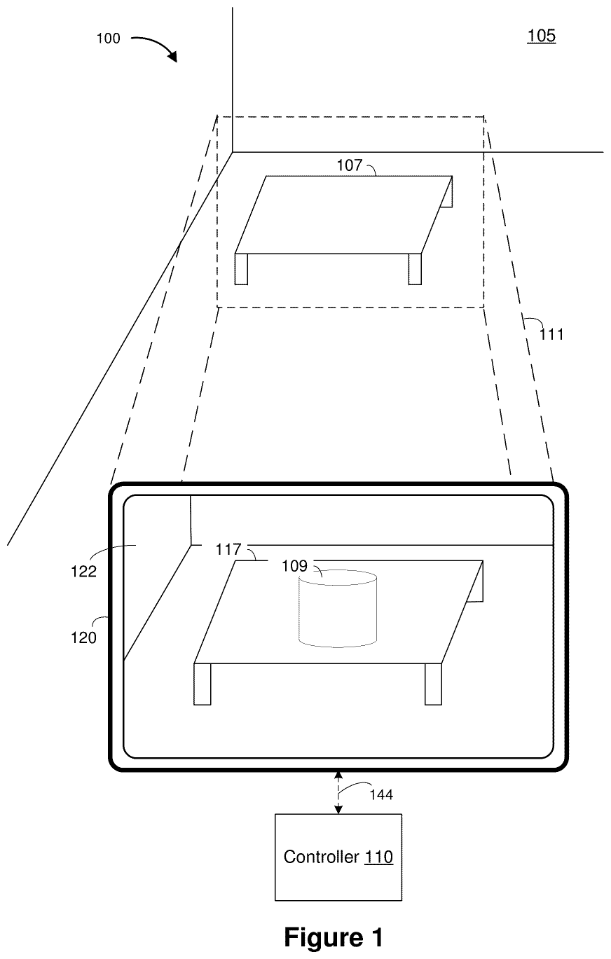

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

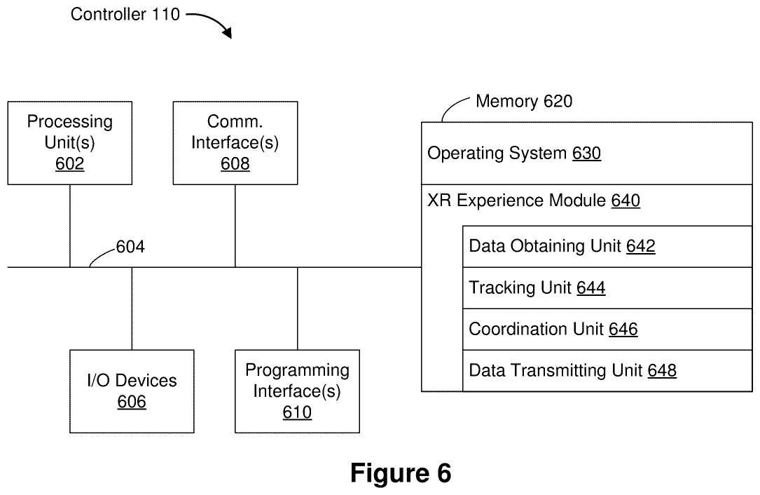

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 6. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

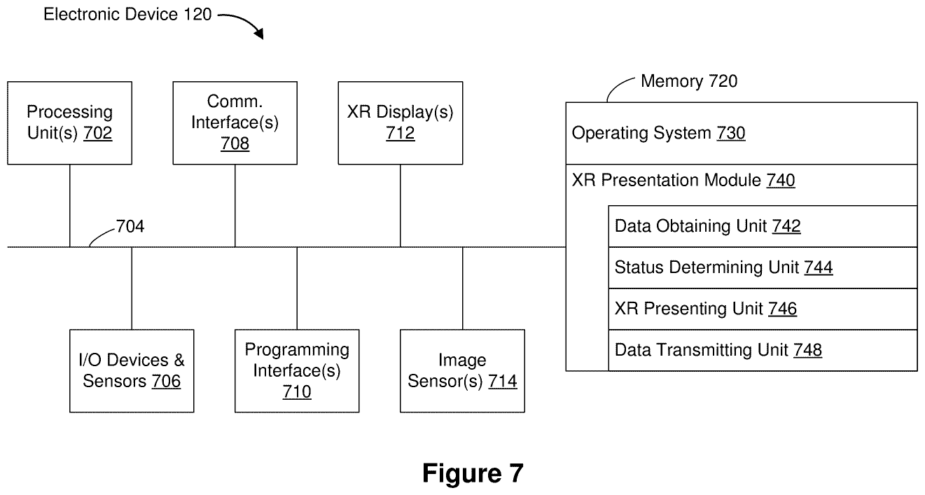

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is virtually or physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 7.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

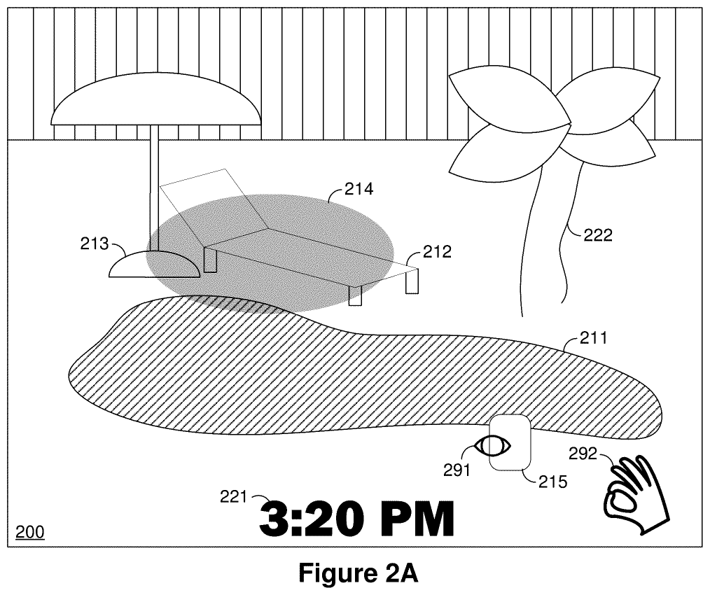

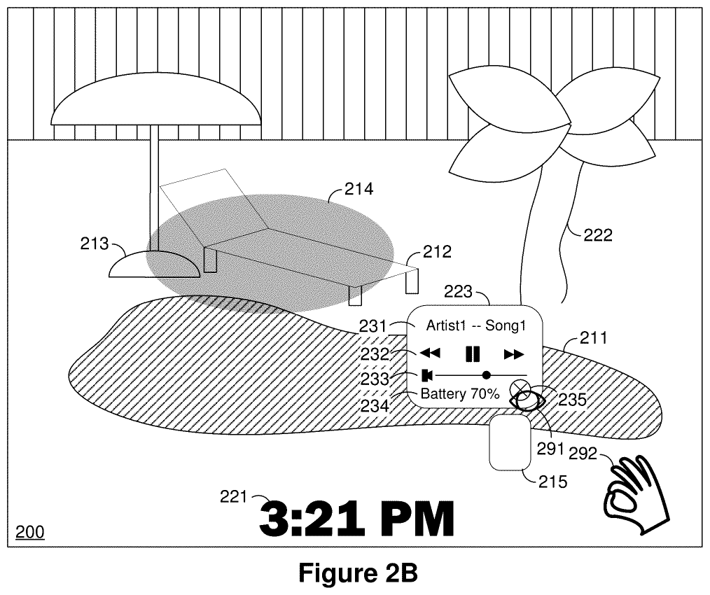

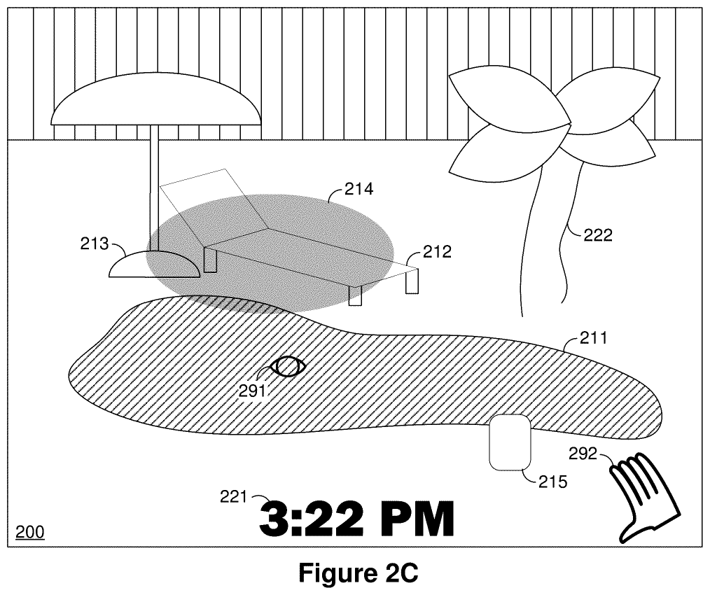

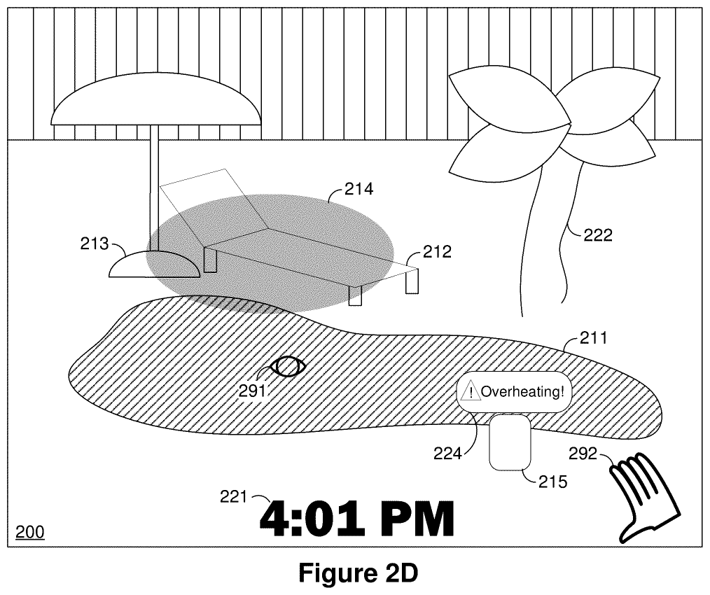

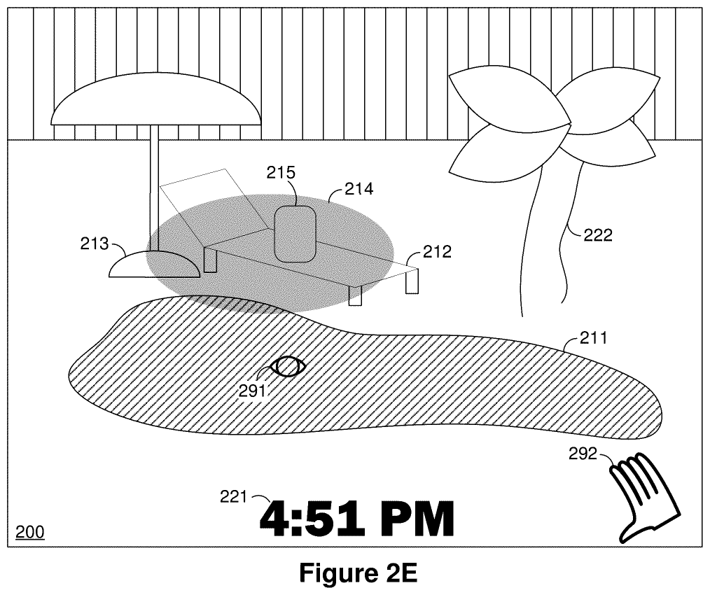

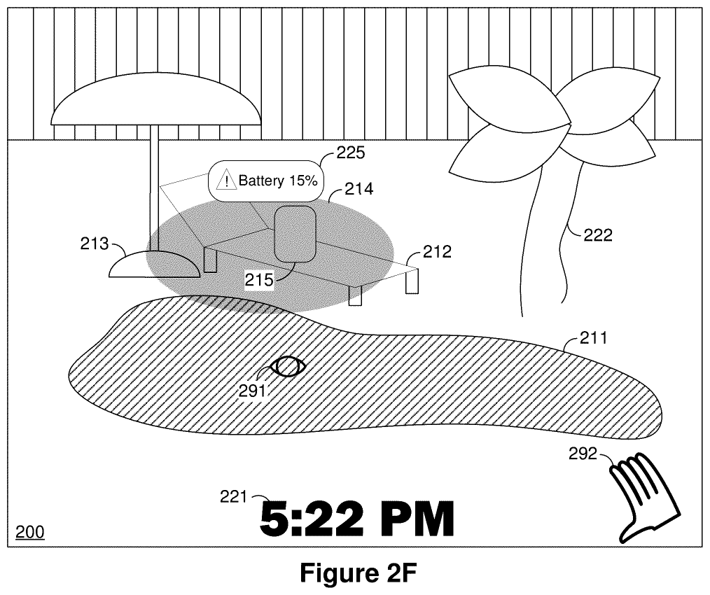

FIGS. 2A-2F illustrate a first XR environment 200 based on a physical environment of a backyard from the perspective of a user of an electronic device displayed, at least in part, by a display of the electronic device. In various implementations, the electronic device includes multiple displays (e.g., a left display positioned in front of a left eye of a user and a right display positioned in front of a right eye of the user) configured to provide a stereoscopic view of the first XR environment 200. For ease of illustration, FIGS. 2A-2F illustrate the first XR environment 200 as presented on a single one of the multiple displays.

In various implementations, the perspective of the user is from a location of an image sensor of the electronic device. For example, in various implementations, the electronic device is a handheld electronic device and the perspective of the user is from a location of the image sensor of the handheld electronic device directed towards the physical environment. In various implementations, the perspective of the user is from the location of a user of the electronic device. For example, in various implementations, the electronic device is a head-mounted electronic device and the perspective of the user is from a location of the user directed towards the physical environment, generally approximating the field-of-view of the user if the head-mounted electronic device were not present. In various implementations, the perspective of the user is from the location of an avatar of the user. For example, in various implementations, the first XR environment 200 is a virtual environment and the perspective of the user is from the location of an avatar or other representation of the user directed towards the virtual environment.

FIGS. 2A-2F illustrate the first XR environment 200 during a series of time periods. In various implementations, each time period is an instant, a fraction of a second, a few seconds, a few hours, a few days, or any length of time.

The first XR environment 200 includes a plurality of objects, including one or more real objects (e.g., a pool 211, a chair 212, an umbrella 213, a speaker 215, and a hand 292) and one or more virtual objects (e.g., a virtual clock 221, and a virtual tree 222). The umbrella 213 casts a shadow on the chair 212 resulting in an area of shade 214. In various implementations, certain objects (such as the real objects and the virtual tree 222) are presented at a location in the first XR environment 200, e.g., at a location defined by three coordinates in a three-dimensional (3D) XR coordinate system. Accordingly, when the electronic device moves in the first XR environment 200 (e.g., changes either position and/or orientation), the objects are moved on the display of the electronic device, but retain their (possibly time-dependent) location in the first XR environment 200. Such virtual objects that, in response to motion of the electronic device, move on the display, but retain their position in the first XR environment 200 are referred to as world-locked objects. In various implementations, certain virtual objects (such as the virtual clock 221) are displayed at locations on the display such that when the electronic device moves in the first XR environment 200, the objects are stationary on the display on the electronic device. Such virtual objects that, in response to motion of the electronic device, retain their location on the display are referred to as head-locked objects or display-locked objects.

FIGS. 2A-2F illustrate a gaze location indicator 291 that indicates a gaze location of the user, e.g., where in the first XR environment 200 the user is looking. Although the gaze location indicator 291 is illustrated in FIGS. 2A-2F, in various implementations, the gaze location indicator 291 is not displayed by the electronic device.

During the first time period, the electronic device detects the speaker 215 in the first XR environment 200 and determines one or more statuses of the speaker 215. For example, during the first time period, the electronic device determines that a battery level of the speaker 215 is 85% and a temperature level of the speaker 215 is 15%. In various implementations, the electronic device determines the battery level and/or the temperature level by transmitting a status query to the speaker 215 and receiving a status response indicating the battery level and/or the temperature level. In various implementations (as discussed further below), if the battery level is below a battery level threshold, the electronic device displays an indicator of the battery level (or an indicator of a low battery level) and if the temperature level is above a temperature level threshold, the electronic device displays an indicator of the temperature level (or an indicator of a high temperature level). During the first time period, the electronic device determines that the battery level of 85% is above a battery level threshold and that the temperature level of 15% is below a temperature level threshold. Accordingly, the electronic device does not display an indicator.

During the first time period, the user is looking at the speaker 215 (as indicated by the gaze location indicator 291) and performs a gesture with the hand 292 (e.g., contacting the index finger and thumb). Accordingly, during the first time period, the user selects the speaker 215.

FIG. 2B illustrates the first XR environment 200 during a second time period subsequent to the first time period. During the second time period, in response to detecting the user selecting the speaker 215, the first XR environment 200 includes a speaker window 223. The speaker window 223 is a world-locked virtual object displayed in association with the speaker 215, e.g., near the speaker 215, above the speaker 215, or in front of the speaker 215. The speaker window 223 includes information regarding the speaker 215 and affordances for manipulating the speaker 215. For example, the speaker window 223 includes a track listing 231 indicating the song and artist of the track currently being played by the speaker 215. The speaker window 223 includes playback affordances 232 which, when selected by the user, pause or change the track currently being played by the speaker 215. The speaker window 223 includes a volume affordance 233 indicating a current volume (and, when selected, allowing a change in the current volume) of the track currently being played by the speaker 215. The speaker window 223 includes a battery level display 234 showing the current battery level of the speaker 215. The speaker window 223 includes a close affordance 235 which, when selected, closes the speaker window 223.

During the second time period, because the speaker window 223 is displayed, the electronic device does not compare the battery level and/or the temperature level to the corresponding threshold to determine whether to display an indicator.

During the second time period, the user is looking at the close affordance 235 (as indicated by the gaze location indicator 291) and performs a gesture with the hand 292 (e.g., contacting the index finger and thumb). Accordingly, during the second time period, the user selects the close affordance 235.

FIG. 2C illustrates the first XR environment 200 during a third time period subsequent to the second time period. During the third time period, in response to detecting the user selecting the close affordance 235, the first XR environment 200 ceases to include the speaker window 223.

During the third time period, the electronic device determines that a battery level of the speaker 215 is 80% and a temperature level of the speaker 215 is 20%. Further, the electronic device determines that the battery level of 80% is above the battery level threshold and that the temperature level of 20% is below the temperature level threshold. Accordingly, the electronic device does not display an indicator.

FIG. 2D illustrates the first XR environment 200 during a fourth time period subsequent to the third time period. During the fourth time period, the electronic device determines that the battery level of the speaker 215 is 50% and the temperature level of the speaker 215 is 80%. Further, the electronic device determines that the battery level of 50% is above the battery level threshold, but that the temperature level of 80% is above the temperature level threshold. Accordingly, during the fourth time period, the first XR environment 200 includes a temperature level indicator 224. The temperature level indicator 224 is a world-locked virtual object displayed in association with the speaker 215. The temperature level indicator 224 is displayed in response to determining that the temperature level of the speaker is above a temperature level threshold and, therefore, the speaker 215 has an overheating status. In various implementations, the temperature level indicator 224 indicates the temperature level and/or the overheating status. Notably, the temperature level indicator 224 is displayed independently of the gaze of the user (which, as indicated by the gaze location indicator 291 is directed to the pool 211) or other selection of the speaker 215 by the user.

FIG. 2E illustrates the first XR environment 200 during a fifth time period subsequent to the fourth time period. Between the fourth time period and the fifth time period, the speaker has been moved from beside the pool 211 to atop the chair 212 in the shade 214. Accordingly, the temperature level of the speaker 215 has dropped.

During the fifth time period, the electronic device determines that the battery level of the speaker 215 is 30% and the temperature level of the speaker 215 is 50%. Further, the electronic device determines that the battery level of 30% is above the battery level threshold and that the temperature level of 50% is below the temperature level threshold. Accordingly, during the fifth time period, the first XR environment 200 does not include the temperature level indicator 224.

FIG. 2F illustrates the first XR environment 200 during a sixth time period subsequent to the fifth time period. During the sixth time period, the electronic device determines that the battery level of the speaker 215 is 15% and the temperature level of the speaker 215 is 50%. Further, the electronic device determines that the temperature level of 50% is below the temperature level threshold, but that the battery level of 15% is below the battery level threshold. Accordingly, during the sixth time period, the first XR environment 200 includes a battery level indicator 225. The battery level indicator 225 is a world-locked virtual object displayed in association with the speaker 215. The battery level indicator 225 is displayed in response to determining that the battery level of the speaker is below a battery level threshold and, therefore, the speaker 215 has a low-battery status. In various implementations, the battery level indicator 225 indicates the battery level and/or the low-battery status. Notably, the battery level indicator 225 is displayed independently of the gaze of the user (which, as indicated by the gaze location indicator 291 is directed to the pool 211) or other selection of the speaker 215 by the user.

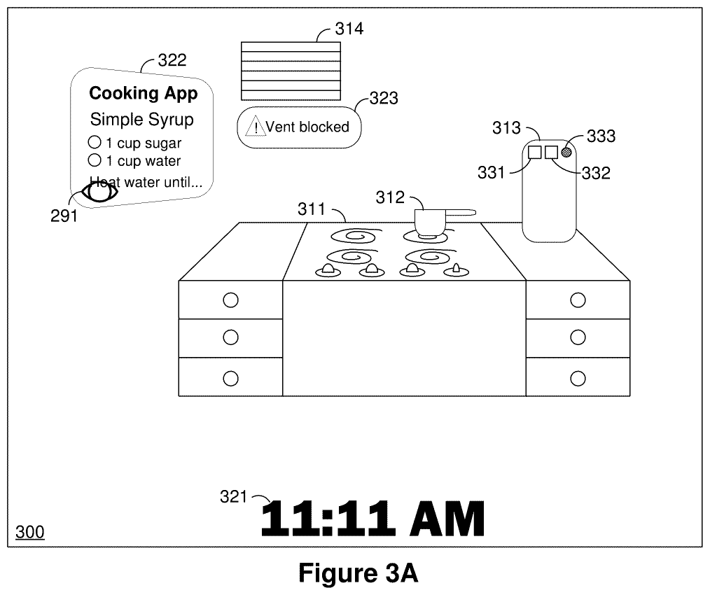

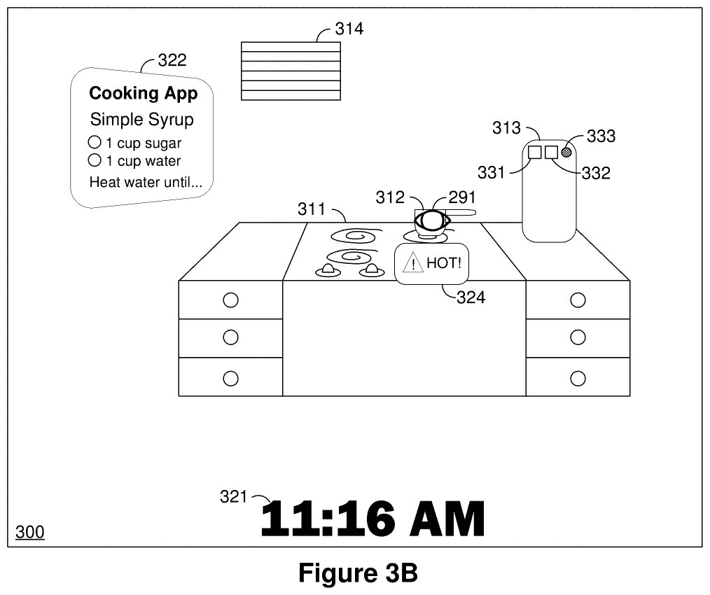

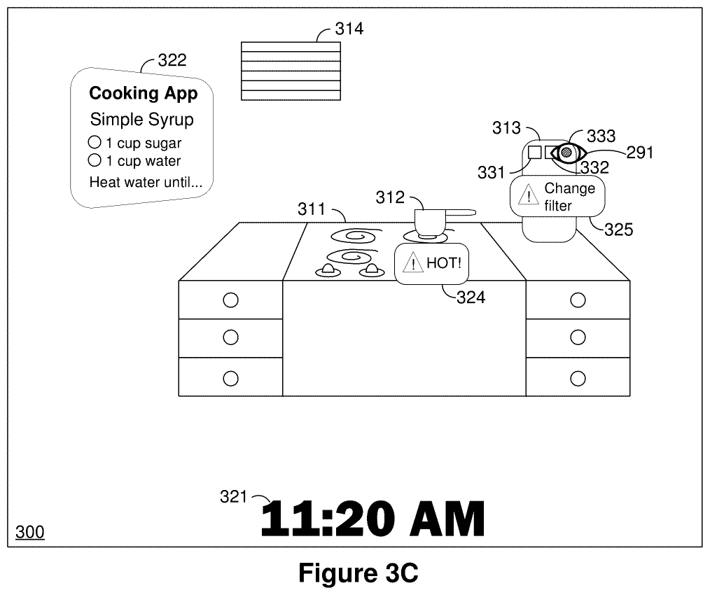

FIGS. 3A-3C illustrate a second XR environment 300 based on a physical environment of a kitchen from the perspective of the user of the electronic device displayed, at least in part, by the display of the electronic device. In various implementations, the electronic device includes multiple displays (e.g., a left display positioned in front of a left eye of a user and a right display positioned in front of a right eye of the user) configured to provide a stereoscopic view of the second XR environment 300. For case of illustration, FIGS. 3A-3C illustrate the second XR environment 300 as presented on a single one of the multiple displays.

FIGS. 3A-3C illustrate the second XR environment 300 during a series of time periods. In various implementations, each time period is an instant, a fraction of a second, a few seconds, a few hours, a few days, or any length of time.

The second XR environment 300 includes a plurality of objects, including one or more real objects (e.g., a stove 311, a pot 312, an air filter 313, and a vent 314) and one or more virtual objects (e.g., a virtual clock 321 and a virtual cooking application window 322). In various implementations, the virtual clock 321 is a display-locked object and the virtual cooking application window 322 is a world-locked object. The air filter 313 includes a power button 331 for activating and deactivating the air filter 313 and an intensity button 332 for varying the intensity of the air filter 313. The air filter 313 further includes a status light 333 that indicates one or more status of the air filter 313. For example, the status light may be green to indicate that the air filter 313 is active, yellow to indicate that the air filter 313 is in need of a filter change, or red to indicate that the air filter 313 is detecting a harmful level of particulates.

FIGS. 3A-3C illustrate the gaze location indicator 291 that indicates a gaze location of the user, e.g., where in the second XR environment 300 the user is looking. Although the gaze location indicator 291 is illustrated in FIGS. 3A-3C, in various implementations, the gaze location indicator 291 is not displayed by the electronic device.

FIG. 3A illustrates the second XR environment 300 during a first time period. During the first time period, the electronic device detects the pot 312 and determines one or more statuses of the pot 312. For example, during the first time period, the electronic device determines that a temperature of the pot 312 is 40° C. In various implementations, the electronic device determines the temperature of the pot 312 using an infrared camera of the electronic device. In various implementations (as discussed further below), if the temperature is above a temperature threshold, the electronic device displays an indicator of the temperature (or an indicator of a high temperature). During the first time period, the electronic device determines that the temperature of 40° C. is below a temperature threshold. Accordingly, the electronic device does not display an indicator of the temperature.

During the first time period, the electronic device detects the air filter 313 and determines one or more statuses of the air filter 313. For example, during the first time period, the electronic device determines that the air filter 313 has a filter status of “needs-changing”. In various implementations, the electronic device determines the filter status by receiving a status message from the air filter 313. However, in various implementations, the air filter 313 has no wireless communication abilities and the electronic device determines the filter status by detecting the status light 333 and determining the filter status based on the status light 333. For example, during the first time period, the status light 333 is yellow and the electronic device determines the filter status of “needs-changing” based on the color. In various implementations, if the filter status is “needs-changing”, the electronic device displays an indicator of the filter status and if the filter status is “acceptable”, the electronic device does not display the indicator. However, in various implementations, because the user can see the status light 333 and is presumably aware that the air filter has an abnormal status, the electronic device does not display the indicator of the filter status unless the user is looking at the air filter 313 providing additional information about which status is abnormal (e.g., the filter status rather than an air-quality status). Because, during the first time period, the user is looking at the virtual cooking application window 322 (as indicated by the gaze location indicator 291), the electronic device does not display an indicator of the filter status during the first time period.

During the first time period, the electronic device detects the vent 314 and determines one or more statuses of the vent 314. For example, during the first time period, the electronic device determines that the vent 314 has a flow status of “blocked”. In various implementations, the electronic device determines the flow status by receiving a status message from the vent 314. However, in various implementations, the vent 314 has no wireless communication abilities (or any electronic components) and the electronic device determines the flow status based on (1) receiving a status message from a smart thermostat that an air conditioner is running and (2) detecting, using an infrared camera, that the temperature of the vent 314 is not significantly lower than the wall in which it is installed. In various implementations, if the flow status is “blocked”, the electronic device displays an indicator of the flow status and if the flow status is “open”, the electronic device does not display the indicator. Because, during the first time period, the flow status is “blocked”, the second XR environment 300 includes a flow status indicator 323. The flow status indicator 323 is a world-locked virtual object displayed in association with the vent 314 indicating the flow status.

FIG. 3B illustrates the second XR environment 300 during a second time period subsequent to the first time period. Between the first time period and the second time period, the vent 314 has been opened and the pot 312 has increased in temperature.

During the second time period, the electronic device determines that the temperature of the pot 312 is 60° C. and that the temperature is above the temperature threshold. Accordingly, during the second time period, the second XR environment 300 includes a temperature indicator 324. The temperature indicator 324 is a world-locked virtual object displayed in association with the pot 312 indicating that the pot 312 is hot (and would burn skin on contact).

During the second time period, the electronic device determines that the air filter 313 still has a filter status of “needs-changing”. However, because the user is looking at the pot 312 (as indicated by the gaze location indicator 291) rather than the air filter 313, the electronic device does not display an indicator of the filter status during the second time period.

During the second time period, the electronic device determines that the vent 314 has a flow status of “open”. Accordingly, during the second time period, the second XR environment 300 does not include the flow status indicator 323.

FIG. 3C illustrates the second XR environment 300 during a third time period subsequent to the second time period. During the third time period, the electronic device determines that the temperature of the pot 312 is 100° C. and that the temperature is above the temperature threshold. Accordingly, during the third time period, the second XR environment 300 includes the temperature indicator 324.

During the third time period, the electronic device determines that the air filter 313 still has a filter status of “needs-changing”. Further, because the user is looking at the air filter 313 (as indicated by the gaze location indicator 291), the second XR environment 300 includes a filter status indicator 325. The filter status indicator 325 is a world-locked virtual object displayed in association with the air filter 313 indicating that a filter of the air filter 313 needs changing.

During the third time period, the electronic device determines that the vent 314 has a flow status of “open”. Accordingly, during the third time period, the second XR environment 300 does not include the flow status indicator 323.

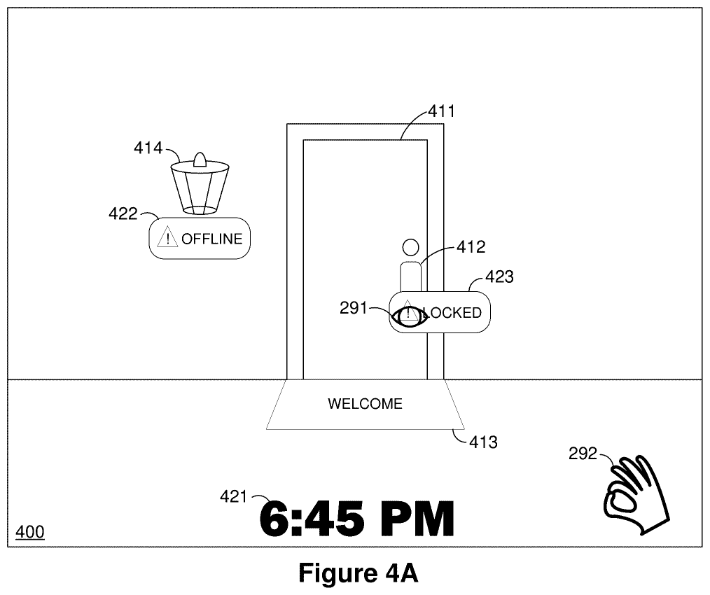

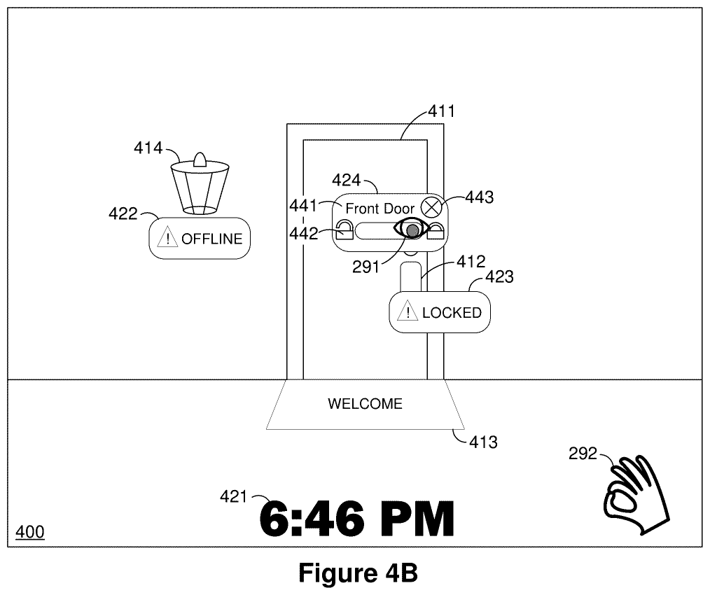

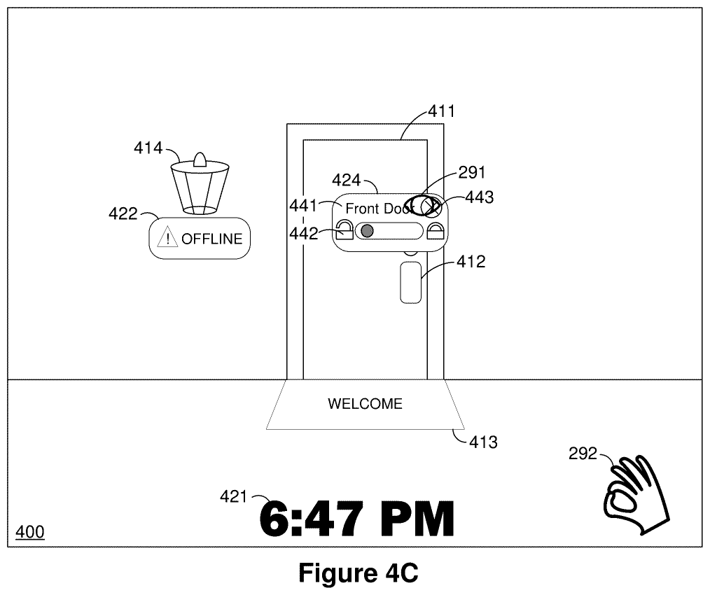

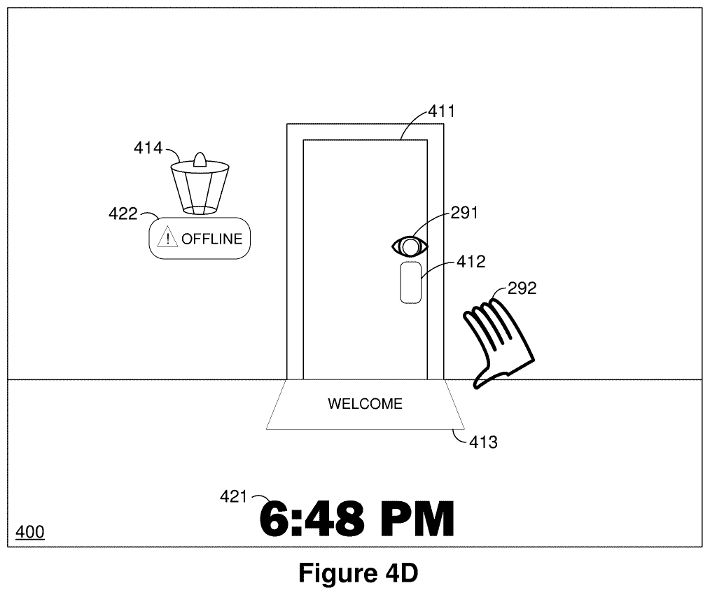

FIGS. 4A-4D illustrate a third XR environment 400 based on a physical environment of a porch from the perspective of the user of the electronic device displayed, at least in part, by the display of the electronic device. In various implementations, the electronic device includes multiple displays (e.g., a left display positioned in front of a left eye of a user and a right display positioned in front of a right eye of the user) configured to provide a stereoscopic view of the third XR environment 400. For case of illustration, FIGS. 4A-4D illustrate the third XR environment 400 as presented on a single one of the multiple displays.

FIGS. 4A-4D illustrate the third XR environment 400 during a series of time periods. In various implementations, each time period is an instant, a fraction of a second, a few seconds, a few hours, a few days, or any length of time.

The third XR environment 400 includes a plurality of objects, including one or more real objects (e.g., a front door 411, a lock 412, a welcome mat 413, a light 414, and the hand 292) and one or more virtual objects (e.g., a virtual clock 421, a connection status indicator 422, and a lock status indicator 423). In various implementations, the virtual clock 421 is a display-locked object and the connection status indicator 422 and the lock status indicator 423 are world-locked objects.

FIGS. 4A-4D illustrate the gaze location indicator 291 that indicates the gaze location of the user, e.g., where in the third XR environment 400 the user is looking. Although the gaze location indicator 291 is illustrated in FIGS. 4A-4D, in various implementations, the gaze location indicator 291 is not displayed by the electronic device.

FIG. 4A illustrates the third XR environment 400 during a first time period. During the first time period, the electronic device detects the light 414 and determines one or more statuses of the light 414. For example, during the first time period, the electronic device determines that a connection status of the light 414 is “offline”. In various implementations, the electronic device determines the connection status by sending a query to the light 414 and either receiving a response (in which case the connection status is “online”) or failing to receive a response (in which case the connection status is “offline”). In various implementations, if the connection status is “offline”, the electronic device displays an indicator of the connection status and, if the connection status is “online”, the electronic device does not display the indicator. During the first time period, the electronic device determines that the connection status is “offline”. Accordingly, during the first time period, the third XR environment 400 includes the connection status indicator 422. The connection status indicator 422 is a world-locked virtual object displayed in association with the light 414 that indicates the connection status. Thus, even though the user can see that the light 414 is off, the connection status indicator 422 further indicates that the light 414 is not simply off (which may be intentional) but cannot be wirelessly turned on (which is unintentional).

During the first time period, the electronic device detects the lock 412 and determines one or more statuses of the lock 412. For example, during the first time period, the electronic device determines that a lock status of the lock 412 is “locked”. In various implementations, the electronic device determines the lock status by sending a query to the lock 412 and receiving a response indicating the lock status.

In various implementations, if the lock status is “locked”, the electronic device displays an indicator of the lock status and, if the lock status is “unlocked”, the electronic device does not display the indicator. For example, if it is expected that the lock 412 is “unlocked” (e.g., a routine is triggered based on detecting that the location of the user has returned home between the hours of 5 PM and 7 PM that includes turning on the light 414 and unlocking the lock 412 or a user's family member manually unlocks the lock when the user is expected home), the indicator is only displayed if the lock status is “locked”.

However, in various implementations, if the lock status is “unlocked”, the electronic device displays an indicator of the lock status and, if the lock status is “locked”, the electronic device does not display the indicator. For example, if it is expected that the lock 412 is “locked” (e.g., between the hours of 12 AM and 5 AM), the indicator is only displayed if the lock status is “unlocked”.

During the first time period, the electronic device determines that the lock status is “locked” and determines that the lock status is expected to be “unlocked”. Accordingly, during the first time period, the third XR environment 400 includes the lock status indicator 423. The lock status indicator 423 is a world-locked virtual object displayed in association with the lock 412 that indicates the lock status.

During the first time period, the user is looking at the lock status indicator 423 (as indicated by the gaze location indicator 291) and performs a gesture with the hand 292 (e.g., contacting the index finger and thumb). Accordingly, during the first time period, the user selects the lock status indicator 423.

FIG. 4B illustrates the third XR environment 400 at a second time subsequent to the first time. During the second time period, in response to the user selecting the lock status indicator 423, the third XR environment 400 includes a lock window 424. The lock window 424 includes an identifier 441 of the lock 412, a lock toggle affordance 442 for indicating and changing the lock status of the lock 412, and a close affordance 443 which, when selected, closes the lock window 424. During the second time period, the lock toggle affordance 442 indicates that the lock status is “locked”.

During the second time period, the user is looking at the lock toggle affordance 442 (as indicated by the gaze location indicator 291) and performs a gesture with the hand 292 (e.g., contacting the index finger and thumb). Accordingly, during the second time period, the user selects the lock toggle affordance 442.

FIG. 4C illustrates the third XR environment 400 at a third time subsequent to the second time. During the third time period, in response to the user selecting the lock toggle affordance 442, the lock status of the lock 412 is changed to “unlocked” (as indicated by the lock toggle affordance 442). During the third time period, the electronic device determines that the lock status is “unlocked” and determines that the lock status is expected to be “unlocked”. Accordingly, during the third time period, the third XR environment 400 does not include the lock status indicator 423.

During the third time period, the user is looking at the close affordance 443 (as indicated by the gaze location indicator 291) and performs a gesture with the hand 292 (e.g., contacting the index finger and thumb). Accordingly, during the third time period, the user selects the close affordance 443.

FIG. 4D illustrates the third XR environment 400 at a fourth time subsequent to the third time. During the fourth time period, in response to the user selecting the close affordance 443, the lock window 424 is no longer displayed. During the fourth time period, the user is looking at (as indicated by the gaze location indicator 291) and reaching for (as indicated by the hand 292) the now-unlocked front door 411.

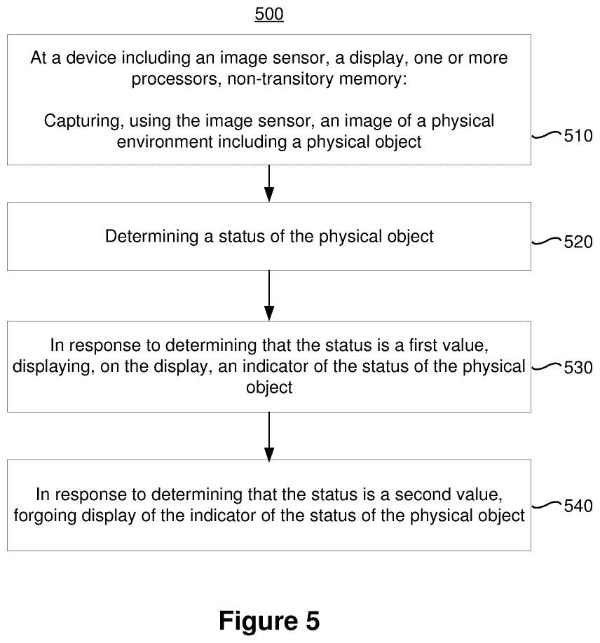

FIG. 5 is a flowchart representation of a method 500 of displaying a status indicator in accordance with some implementations. In various implementations, the method 500 is performed by an electronic device, such as the electronic device 120 of FIG. 1. In various implementations, the method 500 is performed by a device having an image sensor, a display, one or more processors, and non-transitory memory. In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device capturing, using the image sensor, an image of a physical environment including a physical object. In various implementations, the physical object is a smart device including wireless communication capabilities. In various implementations, the physical object is a dumb device lacking wireless communication capabilities. In various implementations, the physical object is a hard device lacking electronic components. In various implementations, the method 500 includes detecting the physical object in the image of the physical environment.

The method 500 continues, in block 520, with the device determining a status of the physical object. For example, in FIGS. 2A-2F, the electronic device determines the battery level of the speaker 215 and the temperature level of the speaker 215. As another example, in FIGS. 3A-3C, the electronic device determines the temperature of the pot 312, the flow status of the vent 314, and the filter status of the air filter 313. As another example, in FIGS. 4A-4D, the electronic device determines the connection status of the light 414 and the lock status of the lock 412.

In various implementations, determining the status of the physical object includes receiving an indication of the status from the physical object. For example, in FIGS. 2A-2F, the electronic device determines the battery level of the speaker 215 and the temperature level of the speaker 215 by wirelessly transmitting a query to the speaker 215 and wirelessly receiving a response indicating the battery level of the speaker 215 and the temperature level of the speaker 215. As another example, in FIGS. 4A-4D, the electronic device determines the lock status of the lock 412 by wirelessly transmitting a query to the lock 412 and receiving a response indicating the lock status of the lock 412. It is to be appreciated that receiving the indication of the status from the physical object may include receiving the indication of status through a network of one or more electronic devices and/or applications. For example, the lock status of the lock 412 may be determined by a smart home application (by receiving information regarding the lock status from the lock 412) and the lock status provided to the device by the smart home application.

In various implementations, determining the status of the physical object is based on the image of the physical environment. In particular, determining the status of the physical object is based on the portion of the image of the physical environment representing the physical object. For example, in various implementations, the lock status of the lock 412 may be determined by determining, based on the image of the lock 412 (from the inside), the orientation of a thumb turn. In various implementations, determining the status of the physical object is based on a status light of the physical object. For example, in FIGS. 3A-3C, the electronic device determines the filter status of the air filter 313 based on detecting that the status light 333 is yellow. In various implementations, the device determines the status of the physical object based on a color of the status light, a brightness of the status light (including activation or inactivation of the status light), or a temporal pattern thereof.

In various implementations, determining the status of the physical object is based on sound produced by the physical object. For example, the device decodes a series of beeps to determine the status of the physical object. In various implementations, the device determines the status of the physical object based on a frequency of the sound, a volume of the sound (including activation or inactivation of the sound), or a temporal pattern thereof.

In various implementations, based on the status light of the physical object or the sound produced by the physical object, the device can determine one or more statuses of a robot vacuum, a smoke alarm, a CO₂ detector, headphones, earbuds, or any other type of device.

In various implementations, determining the status of the physical object is based on an infrared image of the physical object. For example, in FIGS. 3A-3C, the electronic device determines the temperature of the pot 312 based on an infrared image of the pot 312 and determines the flow status of the vent 314 based (in part) on an infrared image of the vent 314.

In various implementations, determining the status of the physical object includes comparing a numerical value to a threshold. For example, in FIGS. 2A-2F, the electronic device determines a low-battery status of the speaker 215 based on comparing the battery level to a battery level threshold. As another example, in FIGS. 3A-3C, the electronic device determines a hot status of the pot 312 based on comparing the temperature of the pot 312 to a temperature threshold.

The method 500 continues, in block 530, with the device, in response to determining that the status is a first value, displaying, on the display, an indicator of the status of the physical object. The method 500 continues, in block 540, with the device, in response to determining that the status is a second value (different from the first value), forgoing display of the indicator of the status of the physical object.

For example, in FIGS. 2A-2F, the temperature level indicator 224 is only displayed when the speaker 215 has an overheating status of “yes” and is not displayed when the speaker 215 has an overheating status of “no”. As another example, in FIGS. 3A-3C, the flow status indicator 323 is displayed only when the vent 314 has a flow status of “blocked” and is not displayed when the vent 314 has a flow status of “open”.

In various implementations, forgoing display of the indicator of the status includes detecting a change in the status from the first value to the second value and ceasing to display the indicator of the status object. For example, in FIG. 4C, in response to detecting a change in the lock status of the lock 412 from “locked” to “unlocked”, the electronic device ceases to display the lock status indicator 423.

In various implementations, displaying the indicator is independent of a gaze of a user. For example, in FIG. 2D, the electronic device displays the temperature level indicator 224 even when the user is not looking at the speaker 215. In various implementations, displaying the indicator is further performed in response to determining that a gaze of a user is directed to the physical object. For example, in FIGS. 3A-3C, the electronic device displays the filter status indicator 325 only when the user is looking at the air filter 313 (and only when the filter status is “needs-changing”).

In various implementations, displaying the indicator includes displaying the indicator as a world-locked virtual object in association with the physical object. In various implementations, displaying the indicator is further performed in response to determining that the user is within a threshold distance of the physical object. Accordingly, the status indicators are displayed only when a user is close enough to see them.

In various implementations, the method 500 further includes determining an expected value of the status and displaying the indicator (in block 530) is further performed in response to determining that the first value is not the expected value. Similarly, in various implementations, forgoing display of the indicator (in block 540) is further performed in response to determining that the second value is the expected value. For example, in FIGS. 4A-4D, the electronic device determines an expected value of the lock status of the lock 412 as “unlocked”. When, as in FIGS. 4A-4B, the lock status is “locked”, the electronic device displays the lock status indicator 423. When, as in FIGS. 4C-4D, the lock status is “unlocked”, the electronic device forgoes display of the lock status indicator 423.

In various implementations, determining the expected value is based on a time of day. For example, in various implementations, the electronic device determines the expected value of the lock status as “unlocked” between 5 PM and 7 PM, but determines the expected value of the lock status as “locked” between 12 AM and 5 AM.

FIG. 6 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 602 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 606, one or more communication interfaces 608 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 610, a memory 620, and one or more communication buses 604 for interconnecting these and various other components.

In some implementations, the one or more communication buses 604 include circuitry that interconnects and controls communications between system components. In some implementations, the one or more I/O devices 606 include at least one of a keyboard, a mouse, a touchpad, a joystick, one or more microphones, one or more speakers, one or more image sensors, one or more displays, and/or the like.

The memory 620 includes high-speed random-access memory, such as dynamic random-access memory (DRAM), static random-access memory (SRAM), double-data-rate random-access memory (DDR RAM), or other random-access solid-state memory devices. In some implementations, the memory 620 includes non-volatile memory, such as one or more magnetic disk storage devices, optical disk storage devices, flash memory devices, or other non-volatile solid-state storage devices. The memory 620 optionally includes one or more storage devices remotely located from the one or more processing units 602. The memory 620 comprises a non-transitory computer readable storage medium. In some implementations, the memory 620 or the non-transitory computer readable storage medium of the memory 620 stores the following programs, modules and data structures, or a subset thereof including an optional operating system 630 and an XR experience module 640.

The operating system 630 includes procedures for handling various basic system services and for performing hardware dependent tasks. In some implementations, the XR experience module 640 is configured to manage and coordinate one or more XR experiences for one or more users (e.g., a single XR experience for one or more users, or multiple XR experiences for respective groups of one or more users). To that end, in various implementations, the XR experience module 640 includes a data obtaining unit 642, a tracking unit 644, a coordination unit 646, and a data transmitting unit 648.

In some implementations, the data obtaining unit 642 is configured to obtain data (e.g., presentation data, interaction data, sensor data, location data, etc.) from at least the electronic device 120 of FIG. 1. To that end, in various implementations, the data obtaining unit 642 includes instructions and/or logic therefor, and heuristics and metadata therefor.

In some implementations, the tracking unit 644 is configured to map the physical environment 105 and to track the position/location of at least the electronic device 120 with respect to the physical environment 105 of FIG. 1. To that end, in various implementations, the tracking unit 644 includes instructions and/or logic therefor, and heuristics and metadata therefor.

In some implementations, the coordination unit 646 is configured to manage and coordinate the XR experience presented to the user by the electronic device 120. To that end, in various implementations, the coordination unit 646 includes instructions and/or logic therefor, and heuristics and metadata therefor.

In some implementations, the data transmitting unit 648 is configured to transmit data (e.g., presentation data, location data, etc.) to at least the electronic device 120. To that end, in various implementations, the data transmitting unit 648 includes instructions and/or logic therefor, and heuristics and metadata therefor.

Although the data obtaining unit 642, the tracking unit 644, the coordination unit 646, and the data transmitting unit 648 are shown as residing on a single device (e.g., the controller 110), it should be understood that in other implementations, any combination of the data obtaining unit 642, the tracking unit 644, the coordination unit 646, and the data transmitting unit 648 may be located in separate computing devices.

Moreover, FIG. 6 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 6 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 7 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 702 (e.g., microprocessors, ASICs, FPGAs, GPUs, CPUs, processing cores, and/or the like), one or more input/output (I/O) devices and sensors 706, one or more communication interfaces 708 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 710, one or more XR displays 712, one or more optional interior- and/or exterior-facing image sensors 714, a memory 720, and one or more communication buses 704 for interconnecting these and various other components.

In some implementations, the one or more communication buses 704 include circuitry that interconnects and controls communications between system components. In some implementations, the one or more I/O devices and sensors 706 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 712 are configured to provide the XR experience to the user. In some implementations, the one or more XR displays 712 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 712 correspond to diffractive, reflective, polarized, holographic, etc. waveguide displays. For example, the electronic device 120 includes a single XR display. In another example, the electronic device includes an XR display for each eye of the user. In some implementations, the one or more XR displays 712 are capable of presenting MR and VR content.

In some implementations, the one or more image sensors 714 are configured to obtain image data that corresponds to at least a portion of the face of the user that includes the eyes of the user (any may be referred to as an eye-tracking camera). In some implementations, the one or more image sensors 714 are configured to be forward-facing so as to obtain image data that corresponds to the physical environment as would be viewed by the user if the electronic device 120 was not present (and may be referred to as a scene camera). The one or more optional image sensors 714 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 720 includes high-speed random-access memory, such as DRAM, SRAM, DDR RAM, or other random-access solid-state memory devices. In some implementations, the memory 720 includes non-volatile memory, such as one or more magnetic disk storage devices, optical disk storage devices, flash memory devices, or other non-volatile solid-state storage devices. The memory 720 optionally includes one or more storage devices remotely located from the one or more processing units 702. The memory 720 comprises a non-transitory computer readable storage medium. In some implementations, the memory 720 or the non-transitory computer readable storage medium of the memory 720 stores the following programs, modules and data structures, or a subset thereof including an optional operating system 730 and an XR presentation module 740.

The operating system 730 includes procedures for handling various basic system services and for performing hardware dependent tasks. In some implementations, the XR presentation module 740 is configured to present XR content to the user via the one or more XR displays 712. To that end, in various implementations, the XR presentation module 740 includes a data obtaining unit 742, a status determining unit 744, an XR presenting unit 746, and a data transmitting unit 748.

In some implementations, the data obtaining unit 742 is configured to obtain data (e.g., presentation data, interaction data, sensor data, location data, etc.) from at least the controller 110 of FIG. 1. To that end, in various implementations, the data obtaining unit 742 includes instructions and/or logic therefor, and heuristics and metadata therefor.

In some implementations, the status determining unit 744 is configured to determining one or more statuses of one or more physical objects. To that end, in various implementations, the status determining unit 744 includes instructions and/or logic therefor, and heuristics and metadata therefor.

In some implementations, the XR presenting unit 746 is configured to selectively display, via the one or more XR displays 712, status indicators based on the one or more statuses. To that end, in various implementations, the XR presenting unit 746 includes instructions and/or logic therefor, and heuristics and metadata therefor.

In some implementations, the data transmitting unit 748 is configured to transmit data (e.g., presentation data, location data, etc.) to at least the controller 110. In some implementations, the data transmitting unit 748 is configured to transmit authentication credentials to the electronic device. To that end, in various implementations, the data transmitting unit 748 includes instructions and/or logic therefor, and heuristics and metadata therefor.

Although the data obtaining unit 742, the status determining unit 744, the XR presenting unit 746, and the data transmitting unit 748 are shown as residing on a single device (e.g., the electronic device 120), it should be understood that in other implementations, any combination of the data obtaining unit 742, the status determining unit 744, the XR presenting unit 746, and the data transmitting unit 748 may be located in separate computing devices.

Moreover, FIG. 7 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 7 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device having an image sensor, a display, one or more processors, and non-transitory memory;
capturing, using the image sensor, an image of a physical environment including a physical object;
determining a status of the physical object;
in response to determining that the status is a first value, displaying, on the display, an indicator of the status of the physical object; and
in response to determining that the status of the physical object is a second value, forgoing display of the indicator of the status of the physical object.

2. The method of claim 1, wherein determining the status of the physical object includes receiving an indication of the status from the physical object.

3. The method of claim 1, wherein determining the status of the physical object is based on the image of the physical environment.

4. The method of claim 3, wherein determining the status of the physical object is based on a status light of the physical object.

5. The method of claim 1, wherein determining the status of the physical object is based on sound produced by the physical object.

6. The method of claim 1, wherein determining the status of the physical object is based on an infrared image of the physical object.

7. The method of claim 1, wherein determining the status of the physical object includes comparing a numerical value to a threshold.

8. The method of claim 1, wherein displaying the indicator is independent of a gaze of a user.

9. The method of claim 1, wherein displaying the indicator is further performed in response to determining that a gaze of a user is directed to the physical object.

10. The method of claim 1, wherein displaying the indicator includes displaying the indicator as a world-locked virtual object in association with the physical object.

11. The method of claim 1, wherein displaying the indicator is further performed in response to determining that the user is within a threshold distance of the physical object.

12. The method of claim 1, further comprising determining an expected value of the status, wherein displaying the indicator is further performed in response to determining that the first value is not the expected value.

13. The method of claim 12, wherein determining the expected value is based on a time of day.

14. A device comprising:
an image sensor;
a display;
a non-transitory memory; and
one or more processors to:
capture, using the image sensor, an image of a physical environment including a physical object;
determine a status of the physical object;
in response to determining that the status is a first value, display, on the display, an indicator of the status of the physical object; and
in response to determining that the status of the physical object is a second value, forgo display of the indicator of the status of the physical object.

15. The device of claim 14, wherein the one or more processors are to determine the status of the physical object by receiving an indication of the status from the physical object.

16. The device of claim 14, wherein the one or more processors are to determine the status of the physical object based on the image of the physical environment.

17. The device of claim 14, wherein the one or more processors are to display the indicator independent of a gaze of a user.

18. The device of claim 14, wherein the one or more processors are to display the indicator by displaying the indicator as a world-locked virtual object in association with the physical object.

19. The device of claim 14, wherein the one or more processors are further to determine an expected value of the status and display the indicator in response to determining that the first value is not the expected value.

20. A non-transitory memory storing one or more programs, which, when executed by one or more processors of a device including an image sensor and a display, cause the device to:
capture, using the image sensor, an image of a physical environment including a physical object;
determine a status of the physical object;
in response to determining that the status is a first value, display, on the display, an indicator of the status of the physical object; and
in response to determining that the status of the physical object is a second value, forgo display of the indicator of the status of the physical object.
